(19) United States
(12) Patent Application Publication
(10) Pub. No.: US 2025/0164177 A1
(43) Pub. Date: May 22, 2025

(54) REFRIGERATOR

(71) Applicant: LG ELECTRONICS INC., Seoul (KR)

(72) Inventors: Wonjun LEE, Seoul (KR); Hanjin JUNG, Seoul (KR); Mi Young KIM, Seoul (KR); Suhyeon SON, Seoul (KR)

(73) Assignee: LG ELECTRONICS INC., Seoul (KR)

(21) Appl. No.: 18/841,505

(22) PCT Filed: Nov. 23, 2022
(86) PCT No.: PCT/KR2022/018554

§ 371 Date: Aug. 26, 2024

(30) Foreign Application Priority Data
Feb. 28, 2022 (KR) 10-2022-0026210

(51) Int. Cl. F25D 23/02; E05F 15/75; F25D 23/06

(52) U.S. Cl. CPC F25D 23/028; E05F 15/75; F25D 23/063; E05Y 2900/31; F25D 2700/02

(57) ABSTRACT

The present disclosure relates to a refrigerator provided with a sensing part in a door, which determines whether there's a request to open the door, thereby ensuring accurate detection of a user's request to open the door and enabling automatic door opening.

### TECHNICAL FIELD

The present disclosure relates to a new type of refrigerator that is capable of accurately detecting a user's request to open a door and automatically opening the door.

### BACKGROUND

In general terms, a refrigerator is a home appliance that uses cold air to provide long-term storage. The refrigerator has at least one storage compartment in which a storage is stored, and the storage compartment is opened and closed by a door.

Conventionally, various technologies for automatically opening a door of a refrigerator have been developed. That is, in order to open the door, a user must manually open it. However, in a situation in which it is difficult for the user to open the door manually (for example, when the user is holding objects in both hands), the door may be automatically opened.

Accordingly, in recent years, various technologies have been provided to detect a user's request to open a door by providing a switch or a sensor in a refrigerator and to open the door automatically when the door opening request is confirmed. In this regard, it is presented in Korean Patent Publication No. 10-2017-011856, Korean Patent Publication No. 10-2011-0009348, Korean Patent Publication No. 10-2011-0040030, and Korean Patent Publication No. 10-2020-0045798.

However, among the aforementioned conventional technologies, there is a problem in that there were a lot of errors in the technology for detecting a door opening request to open the door automatically.

For example, in the case of a technology that uses a non-contact sensor to detect a door opening request, the door may be opened undesirably by a user or a pet passing by.

In addition, in the case of a technology that uses a contact sensor or a switch to detect a door opening request, an impact due to unintended contact or collision of a user is erroneously recognized as the door opening request.

In particular, in the case of the contact sensor or the switch, a user cannot adjust the contact sensitivity. This means that, when the sensor or the switch is placed in a refrigerator cabinet, it is difficult to make an accurate setting in terms of a sensing level, which may be sensitive depending on the installation environment. Accordingly, there is a problem of the door being opened regardless of the user's intention.

Furthermore, the sensor or the switch for detecting a door opening request is disposed inside the cabinet. Accordingly, when a failure of the sensor or the switch occurs, it is difficult to repair it.

### DETAILED DESCRIPTION OF THE DISCLOSURE

### Technical Problem

The present disclosure has been devised to solve various problems according to the prior art.

According to a purpose of the present disclosure, it is possible to accurately detect a door opening request by a user. This solves the problem of an automatic door opening device being operated undesirably, causing the door to open.

In addition, according to another purpose of the present disclosure, a user may easily set a desired level of operating force. Accordingly, the door opening request, which may be different for each user, may be set differently.

In addition, another purpose of the present disclosure is to facilitate repair and maintenance of a structure or device for detecting the door opening request. Accordingly, even if a failure occurs in a sensor or a switch, the sensor or the switch may be easily replaced without disassembling a cabinet.

### Technical Solution

In order to achieve the above purposes, a refrigerator according to the present disclosure comprises a structure or a member for detecting or confirming a request for automatic opening of a door by a user. Accordingly, a time point for automatically opening the door may be accurately determined, and the door may be automatically opened in accordance with the user's request.

According to the present disclosure, a sensing part may be provided in the door to sense the door opening request.

According to the present disclosure, the sensing part may be configured to sense that the door is pressed toward a cabinet. Accordingly, when the door is pressed, it is determined that the door is requested to open.

According to the present disclosure, the sensing part may be mounted to be received by the surface of the door. Accordingly, external exposure of the sensing part may be minimized, and damage or the like may be prevented.

According to the present disclosure, the sensing part may be disposed on a surface of the door opposite to the cabinet.

According to the present disclosure, the sensing part may be disposed on any circumferential surface of the door.

According to the present disclosure, the sensing part may include a pressing member which moves in a direction opposite to the cabinet when the door is pressed. Accordingly, whether the door opens automatically may be determined according to an amount of pressure applied to the door. That is, when the door is pressed in excess of a set amount of pressure, an operation control or an operation for automatically opening the door may be performed.

According to the present disclosure, the sensing part may be configured to sense a movement of the pressing member when the door is pressed. Accordingly, an operation control for automatically opening the door may be selectively performed according to the amount of pressure applied to the door.

According to the present disclosure, the sensing part may be provided in a mounting groove.

According to the present disclosure, the sensing part may be provided with a member for sensing the movement of the pressing member when the door is pressed.

According to the present disclosure, a sensing member may be configured as at least one of a sensor or a switch.

According to the present disclosure, the sensing member may be disposed on the moving path of the pressing member.

According to the present disclosure, the pressing member may include a pressing end which is pressed while being in contact with the cabinet when the door is pressed.

According to the present disclosure, the pressing member may include a contact end which extends in the moving direction of the pressing end.

According to the present disclosure, the contact end may be configured to selectively contact the sensing member or to press the sensing member. That is, it may be determined that a door opening request is being made when the contact end contacts the sensing member, or it may be determined that a door opening request is being made when the contact end presses the sensing member.

According to the present disclosure, the pressing end may be formed to be in surface contact with the cabinet. Accordingly, the pressing member may be accurately moved in the opposite direction to the cabinet.

According to the present disclosure, a position of the contact end may be adjusted. By adjusting the position of the contact end, a pressing force of the door for automatic opening may be adjusted.

According to the present disclosure, the contact end may be installed such that the position thereof is adjusted from the pressing end toward the moving direction of the pressing member.

According to the present disclosure, a restoring member may be provided between the facing surfaces of the pressing member and the sensing member. Accordingly, when the pressure of the door is released, the pressing member may maintain the contact state with the cabinet.

According to the present disclosure, the pressing member may be disposed to have a shorter protrusion distance toward the cabinet than a gasket member provided in the door. This reduces the noise caused by impact generated by the pressing member hitting the cabinet when the door is closed.

According to the present disclosure, the sensing part may include a casing in which the sensing member is accommodated and the pressing member is disposed. Accordingly, the sensing part may be provided as a separate assembly from the door.

According to the present disclosure, at least a portion of the pressing member may protrude from the casing.

According to the present disclosure, the sensing part may be detachably mounted on the door. Thus, replacement or maintenance of the sensing part may be easily performed.

According to the present disclosure, the sensing part may be provided on at least one circumferential portion of the door. Accordingly, even if unnecessary pressure is applied to a part of the door that is frequently hit, the problem of the door opening automatically may be prevented.

According to the present disclosure, the sensing part may be provided at least one corner portion of the door. Accordingly, even if unnecessary pressure is applied to a part of the door that is frequently hit, the problem of the door opening automatically may be prevented.

According to the present disclosure, the door may include a door opening part that opens the door by being spaced apart from the cabinet.

According to the present disclosure, the door opening part may be configured to be operated when an opening request of the door is confirmed by the sensing part.

According to the present disclosure, the door opening part may be disposed on any one of the facing surfaces between the cabinet and the door and configured to push toward the other of the facing surface to open the door.

### Advantageous Effects

As described above, a refrigerator of the present disclosure may obtain the following effects.

According to the refrigerator of the present disclosure, since a user's request to open the door is confirmed when a specific part of the door is pressed above a set pressure, the problem of unwanted door opening may be solved.

According to the refrigerator of the present disclosure, an operating force (door pressing force) desired by the user may be easily set simply by adjusting the protruding distance of a pressing end from a contact end.

According to the refrigerator of the present disclosure, a sensing part of the door is provided on the door at the detachable position so that the operating force (door pressing force) may be easily adjusted or maintained. That is, it is possible to replace a sensor or a switch or adjust the operating force without disassembling the cabinet.

### BRIEF DESCRIPTION OF THE DRAWINGS

FIG. 1 is a perspective view illustrating an appearance of a refrigerator according to an embodiment of the present disclosure.

FIG. 2 is a perspective view illustrating an open state of a door of the refrigerator according to the embodiment of the present disclosure.

FIG. 3 is a perspective view of a main part illustrating a state in which a sensing part is provided in the door of the refrigerator according to the embodiment of the present disclosure.

FIG. 4 is a perspective view of a main part illustrating a structure of a mounting groove in which the sensing part is mounted on the door of the refrigerator according to the embodiment of the present disclosure.

FIG. 5 is an exploded perspective view of the sensing part of the refrigerator according to the embodiment of the present disclosure.

FIG. 6 is a perspective view of a main part illustrating a state in which the sensing part is provided in the door of the refrigerator, viewed from a different direction of FIG. 3 according to an embodiment of the present disclosure.

FIG. 7 is a cross-sectional view illustrating a state in which the sensing part is provided in the door of the refrigerator according to the embodiment of the present disclosure.

FIG. 8 is a plan view illustrating a state in which a door opening part of a refrigerator is provided according to the embodiment of the present disclosure.

FIG. 9 is a cross-sectional view illustrating a state in which the sensing part is operated when the door of the refrigerator is pressed according to the embodiment of the present disclosure.

FIG. 10 is a perspective view illustrating a state in which the door of the refrigerator is opened by the door opening part according to the embodiment of the present disclosure.

FIG. 11 is a plan view illustrating a state of a sensing part in a state in which a door of a refrigerator is opened by a door opening unit according to an embodiment of the present disclosure.

FIG. 12 is a perspective view illustrating a state of the sensing part when the door of the refrigerator is opened according to the embodiment of the present disclosure.

FIG. 13 is a perspective view illustrating the state of the sensing part, viewed from a different direction of FIG. 12, when the door of the refrigerator is opened according to the embodiment of the present disclosure.

### MODE FOR INVENTION

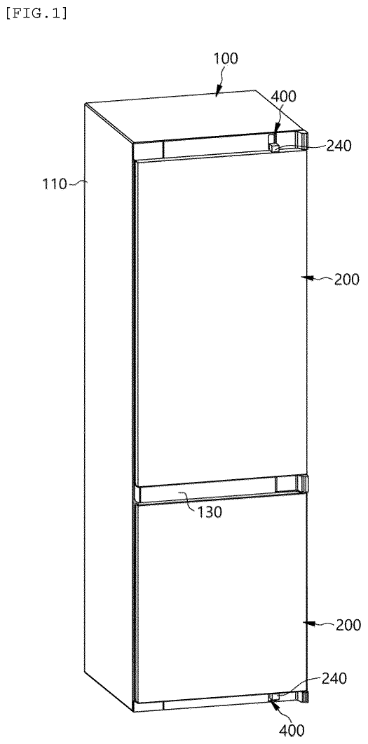

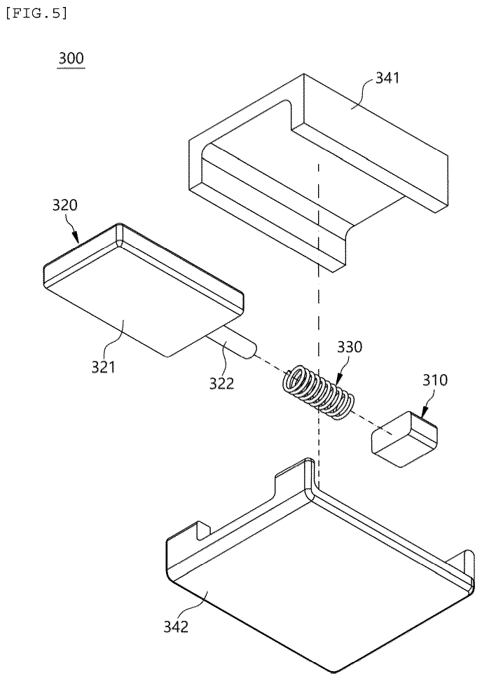

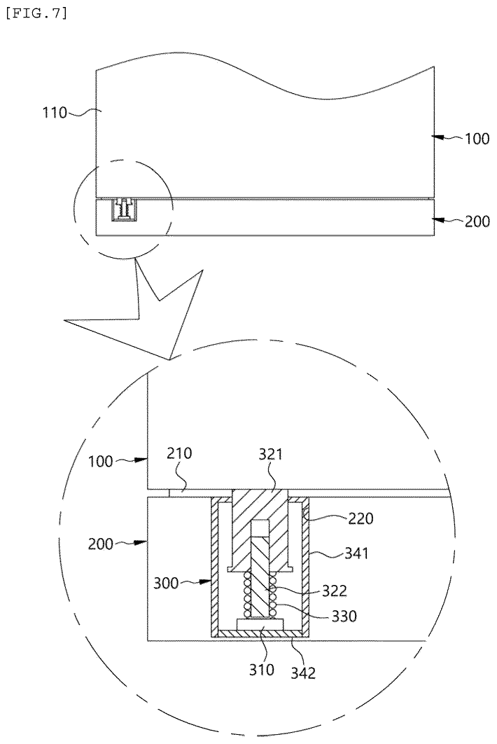

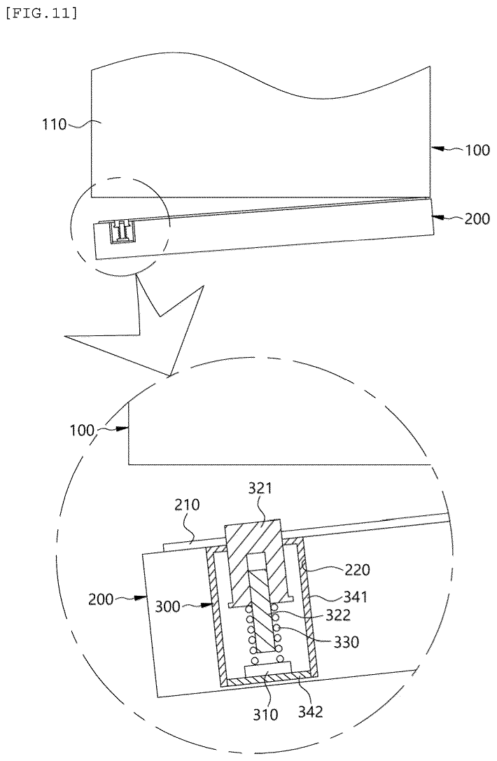

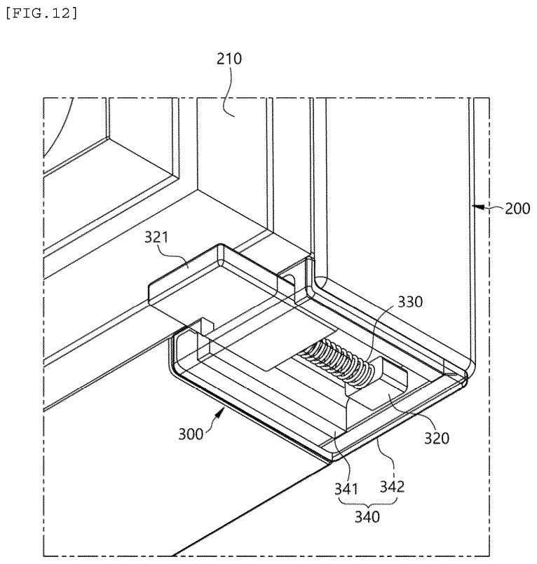

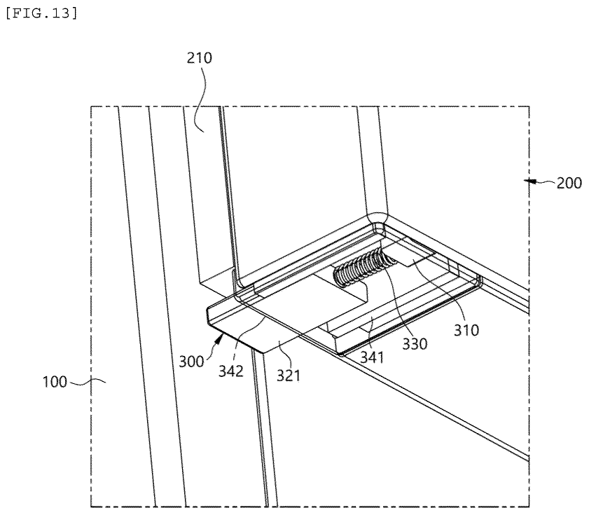

Hereinafter, a preferred embodiment of a refrigerator of the present disclosure will be described with reference to FIGS. 1 to 13.

Prior to the description of the embodiment, the description of each direction will be described with reference to the direction in which the refrigerator is disposed. For example, in a normal refrigerator arrangement, a cabinet 100 or door 200 facing a room (facing a user) is referred to as the front, and a surface of the cabinet 100 adjacent to the wall of the room (or arrangement space) and a surface of the door 200 facing the cabinet 100 while a storage compartment is closed is referred to as the rear.

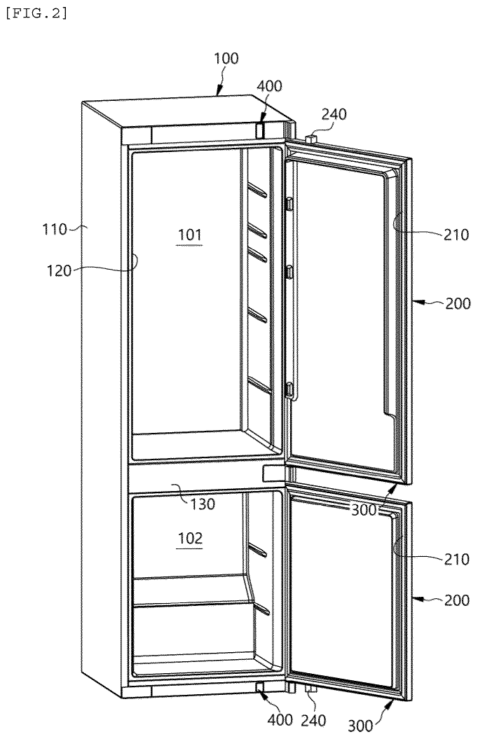

FIGS. 1 and 2 illustrate appearance states of the refrigerator according to the embodiment of the present disclosure.

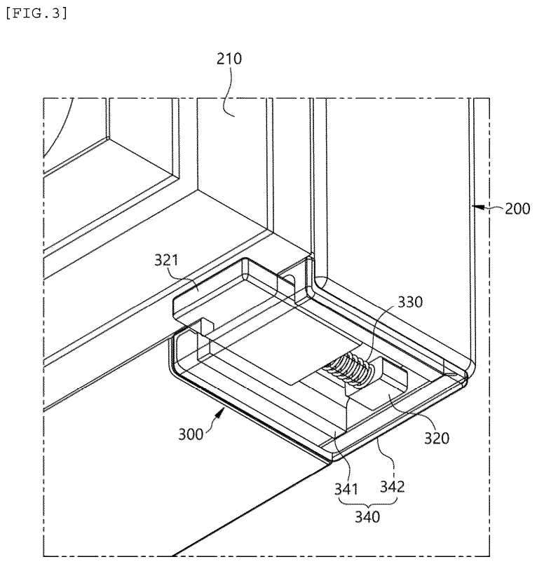

FIGS. 3 to 7 illustrate a structure related to a sensing part according to the embodiment of the present disclosure.

As illustrated in these drawings, the refrigerator according to the embodiment of the present disclosure includes a sensing part 300 for sensing an opening request of the door 200 by a user. In particular, the sensing part 300 may be provided in the door 200 to facilitate assembly work or maintenance, or to accurately detect an opening request of the door 200.

This will be described in more detail with reference to each configuration.

First, the refrigerator according to the embodiment of the present disclosure may include a cabinet 100.

The cabinet 100 may be provided to form an exterior of the refrigerator. The cabinet 100 may include an outer casing 110 forming the exterior and an inner casing 120 forming an inner surface. Although not shown, a member for thermal insulation or strength reinforcement, such as foam or insulating material, may be filled or inserted between the outer casing 110 and the inner casing 120.

At least one storage compartment 101 and 102 may be provided in the cabinet 100. The storage compartments 101 and 102 may store food, beverages, foods, and the like, and may store the stored goods for a long period of time by using cold air generated by a freezing system (not shown).

Two or more storage compartments 101 and 102 may be provided. For example, as shown in the embodiment, the storage compartments 101 and 102 may be provided as an upper storage compartment 101 and a lower storage compartment 102. In this case, the two storage compartments 101 and 102 may be partitioned from each other by a partition wall 103. Although not shown, only one storage compartment may be provided. At least one of the upper or lower storage compartments may be divided into two left and right compartments by another partition wall.

The storage compartments 101 and 102 may be maintained at different temperatures. For example, the upper storage compartment 101 may be maintained at a refrigeration temperature, and the lower storage compartment 102 may be maintained at a freezing temperature. On the contrary, the upper storage compartment 101 may be maintained at a freezing temperature, and the lower storage compartment 102 may be maintained at a refrigeration temperature.

Next, the refrigerator according to the embodiment of the present disclosure may include a door 200.

The door 200 is provided to open and close the storage compartment 101 of the cabinet 100. That is, the storage compartments 101 and 102 of the cabinet 100 may be opened or closed by the operation of the door 200.

The door 200 is disposed in the cabinet 100 to open and close the storage compartments 101 and 102. In this case, the door 200 may be rotatably installed in the cabinet 100 by a hinge (not shown), and may open or close the storage compartments 101 and 102 while being rotated by a user's manipulation.

The door 200 may be provided one by one for each of the storage compartments 101 and 102. Although not shown, two or more doors 200 may be provided to open and close one storage compartment, or two storage compartments may be opened and closed by one door.

Meanwhile, a gasket member 210 may be provided around the rear surface of the door 200 (a surface facing the front surface of the cabinet, a surface facing the storage compartment). When the door 200 is closed, the gasket member 210 blocks a gap between the rear surface of the door 200 and the front surface of the cabinet 100 (close to the front surface of the cabinet) to prevent leakage of cold air.

Next, the refrigerator according to the embodiment of the present disclosure may include a sensing part 300.

The sensing part 300 is a component that senses a user's request to automatically open the door 200. That is, the sensing part 300 may accurately sense the user's intention to open the door 200.

The sensing part 300 is provided in the door 200. That is, since the sensing part 300 is provided in the door 200, it is not necessary to disassemble the cabinet 100 during the assembly work or maintenance of the sensing part 300.

In particular, by providing the sensing part 300 in the door 200, it is possible to maximize the sensing sensitivity according to the operation of the user. That is, if the sensing part 300 is located in the cabinet 100, the sensing sensitivity is inevitably lowered because the door 200 serves to attenuate the operation force. In addition, if the sensing part 300 is located in the cabinet 100, the sensing part 300 may detect the user's request only when the operation force applied to the door 200 is large. In view of this, the sensing part 300 is provided on the door 200 so that accurate detection may be performed even if the operating force applied to the door 200 is small.

The sensing part 300 may be provided on a surface of the door 200 facing the cabinet 100.

Preferably, the sensing part 300 may be provided on at least one circumferential portion of the door 200. That is, the sensing part 300 may be provided at any one of the portions of the door 200 positioned to face the front surface of the cabinet 100.

More preferably, the sensing part 300 may be provided at least one corner portion of the door 200. That is, the sensing part 300 is positioned at the corner of the door 200 so that the user may accurately recognize the position of the sensing part 300.

In particular, the sensing part 300 may be disposed at a corner portion opposite to a portion where a hinge (not shown) of the door 200 is located. This is because, when a pressing force is applied to the door 200, a position change at an opposite side of the door 200 may be larger than a position where the hinge is located.

Of course, the sensing part 300 may be positioned at the other circumferential portion of the door 200 instead of the corner portion of the door 200. That is, if a pressing force is applied to any portion of the door 200 regardless of the position of the sensing part 300, sensing by the sensing part 300 may be performed even if the sensing sensitivity is different.

In the embodiment of the present disclosure, the sensing part 300 is located at any one corner of the lower end of the door 200 on which the partition wall 103 is located. In this case, the front surface of the cabinet 100 to which the sensing part 300, to be described later, is in contact, facing, and pressed may be the front surface of the partition wall 103 in the drawing.

The sensing part 300 may be positioned to be inserted into the surface of the door 200.

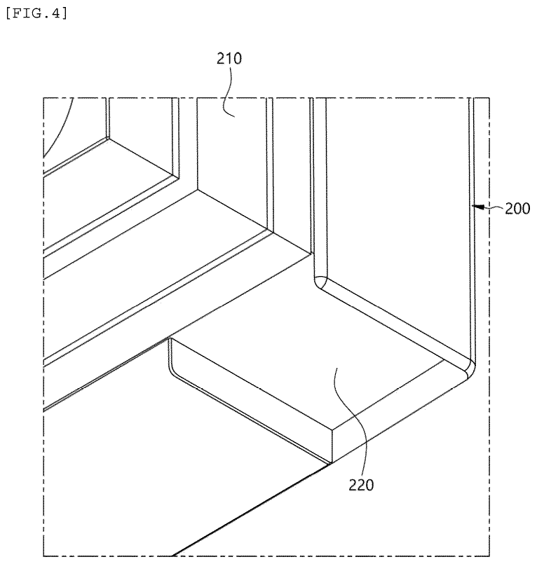

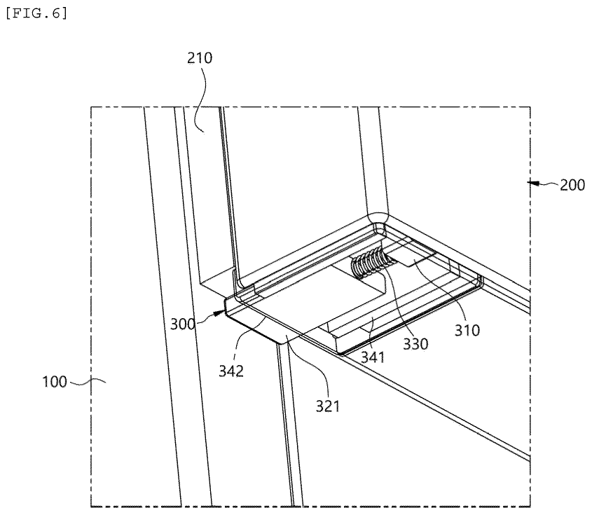

In this case, a mounting groove 220 (refer to FIG. 4) is recessed on the surface of the door 200 facing the cabinet 100, and the sensing part 300 may be mounted in the mounting groove 220. (refer to FIGS. 3 and 6).

For example, the mounting groove 220 may be recessed forward from the rear surface of the door 200 (the surface facing the front surface of the cabinet). In this case, the mounting groove 220 may be formed such that the rear surface (the surface facing the front surface of the cabinet) is open to the rear of the door 200.

As another example, the mounting groove 220 may be formed to be recessed upward from the bottom surface of the door 200. In this case, the mounting groove 220 may be formed such that the bottom surface (the lower side of the door) is opened and at least a portion of the rear surface (the surface facing the front surface of the cabinet) is opened to the rear of the door 200.

As in the illustrated embodiment, the mounting groove 220 formed in the door 200 may be formed to open both the bottom surface and the rear surface.

Although not shown, the mounting groove 220 may be formed to be recessed on a side surface or an upper surface of the door 200. For example, in the case of the door 200 located on the lower side of the two doors 200, the mounting groove 220 may be formed to be recessed on the upper surface of the door 200.

The sensing part 300 may be configured to detect when the door 200 is pressed by a set force. Meanwhile, in the case of a simple touch sensor or a proximity sensor, there may be a risk of sensing even when an unwanted contact occurs in the sensing portion, or may cause malfunction due to static electricity or the like.

In view of this, according to the embodiment of the present disclosure, it is possible to minimize a malfunction by sensing when a door is pressed more than a set force (or distance) and allowing it to be recognized as a door opening request.

To this end, the sensing part 300 may include a sensing member 310 and a pressing member 320.

Here, the sensing member 310 is a member provided to sense a contact or a pressing force of the pressing member 320. That is, the movement of the pressing member 320 may be sensed by the sensing member 310.

The sensing member 310 may include at least one of a sensor or a switch installed on a moving path of the pressing member 320. That is, the sensing member 310 may be configured as a sensor or a switch in which the pressing member 320 is in contact with or is pressed by the movement of the pressing member 320. Accordingly, if the door is pressed or hit to the extent that the pressing member 320 does not move sufficiently, the pressing member 320 does not contact or pressurize the sensing member 310, and the sensing member 310 may not determine as an open request of the door 200.

The sensing member 310 may be configured to provide a sensing signal directly to a door opening part 400 wirelessly or wired, or to provide a sensing signal to a control part (not shown) for controlling the operation of the door opening part 400.

The pressing member 320 may be configured to move by a pressed distance of the door 200 by pressing the door 200 while in contact with the surface facing the cabinet 100. That is, when the door 200 is pressed, the pressing member 320 is configured to move in a direction opposite to the cabinet 100.

The pressing member 320 may include a pressing end 321 and a contact end 322 extending from the pressing end 321.

The pressing end 321 is a portion contacting the surface facing the cabinet 100, and is disposed to pass through the open rear surface of the mounting groove 220 to be exposed to the rear side (front side of the cabinet) of the door 200.

The rear surface of the pressing end 321 (the surface facing the front surface of the cabinet) is disposed to be in contact with the front surface of the cabinet 100. In this case, the rear surface of the pressing end 321 is preferably formed to be in surface contact with the cabinet 100, thereby preventing damage to the front surface of the cabinet 100 due to an impact.

In particular, the pressing member 320 may have a shorter protrusion distance toward the cabinet 100 than a gasket member 210 provided in the door 200. Accordingly, when the door 200 is closed, an impact noise generated when the pressing member 320 collides with the cabinet 100 may be reduced.

Of course, the pressing end 321 may be disposed to protrude further rearwardly from the gasket member 210 according to the needs of the user. Thus, in the closed state of the door 200, the pressing end 321 may be maintained in contact with the front surface of the cabinet 100. Accordingly, even when the pressing force applied to the door 200 is small, the pressing end 321 may be accurately retracted (moved forward), thereby increasing the sensing force.

In addition, the contact end 322 may extend in a moving direction from the pressing end 321. That is, the front surface of the pressing end 321 may extend forward from the front surface (the surface facing the front side of the door). Accordingly, the contact end 322 is moved together with the movement of the pressing end 321 to selectively contact or press the sensing member 310.

The contact end 322 may be formed to have a smaller diameter, width, or thickness than the pressing end 321. In addition, the contact end 322 is configured to be inserted and mounted from the front surface of the pressing end 321 toward the inside of the pressing end 321.

In particular, the contact end 322 may be configured to adjust the protruding length (the length of insertion into the front surface) from the front surface of the pressing end 321. For example, the contact end 322 may be screw-rotatably coupled to the front surface of the pressing end 321 to adjust the protruding distance of the contact end 322. Accordingly, the pressing force of the door 200, which may be sensed by the sensing member 310, may be adjusted.

In addition, a restoring member 330 may be provided between the pressing member 320 and the sensing member 310 to provide a restoring force to move the pressing member 320. Accordingly, when a pressing force of the door 200 is released, the pressing member 320 may be maintained in contact with the cabinet 100, and when a pressing force is provided to the door 200, the pressing member 320 may be accurately operated.

In addition, the sensing part 300 may further include a casing 340 forming an exterior of the sensing part 300.

The sensing member 310 may be accommodated in the casing 340, and at least a portion of the pressing member 320 may protrude to the outside of the casing 340. Accordingly, the sensing member 310 may be protected from an external environment (impact or temperature).

In addition, the casing 340 may be detachably removed on the door 200. That is, the casing 340 may be accommodated and mounted in the mounting groove 220 formed in the door 200. Accordingly, the sensing part 300 may be provided separately from the door 200 and may be integrally installed in the door 200 or may be separated from the door 200.

At least a portion of the rear surface of the casing 340 (the surface facing the front surface of the cabinet) may be formed to be open so that the pressing end 321 forming the pressing member 320 may protrude, and the sensing member 310 may be fixedly disposed on the front surface of the casing 340.

In addition, the casing 340 may be divided into an upper casing 341 and a lower casing 342. Thus, the pressing member 320, the sensing member 310, and the restoring member 330 may be easily installed in the casing 340.

Next, the refrigerator according to the embodiment of the present disclosure may include a door opening part 400.

The door opening part 400 may be operated to open the door 200 away from the cabinet 100 when an opening request of the door 200 is confirmed by the sensing part 300. That is, when the sensing part 300 detects that the door 200 is pressed more than a set force (or distance), the door opening part 400 operates to open the door 200.

The door opening part 400 may include a push member 410 disposed on one of the facing surfaces between the cabinet 100 and the door 200 and installed to protrude toward the other facing surface, and an operation part 420 operating the push member 410.

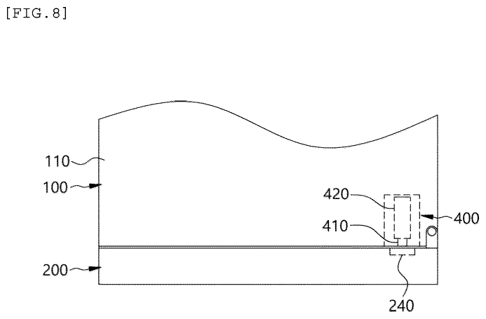

For example, as shown in FIG. 8, the door opening part 400 may be positioned on the front surface of the cabinet 100 and configured such that the push member 410 protrudes toward the door 200. In this case, the push member 410 may be installed to push the door 200 while directly contacting the door 200, or the push member 410 may push a support member 240 additionally formed in the door 200.

The operation part 420 may be configured as a motor, a cylinder, or the like.

Although not shown, the door opening part 400 may be positioned in the door 200 to push the front surface of the cabinet.

Although not shown, the door opening part 400 may be positioned on an upper surface or a lower surface of the cabinet 100.

Hereinafter, the operation of opening the door of the refrigerator according to the embodiment of the present disclosure will be described in more detail.

First, when the door 200 is closed, the storage compartments 101 and 102 in the cabinet 100 are closed from the external environment (room).

When the door 200 is closed, the gasket member 210 provided in the door 200 blocks a gap between the door 200 and the cabinet 100 to prevent leakage of cold air.

In addition, when the door 200 is closed, the rear surface of the pressing end 321 of the pressing member 320 forming the sensing part 300 is maintained in contact with the front surface of the cabinet 100 (the front surface of the partition wall). In this case, the rear surface of the pressing end 321 is in contact with the front surface of the cabinet 100 by the restoring force of the restoring member 330, and the front surface of the contact end 322 is spaced apart from the sensing member 310. This is shown in FIGS. 3, 6, and 7. Although not shown, the front surface of the contact end 322 may be in contact with the sensing member 310, and in this case, it may be contacted with a pressing force that is not detected by the sensing member 310.

In the closed state of the door 200, the user may directly open the door 200, or the door opening part 400 may be operated to automatically open the door 200.

When the user directly opens the door 200, the door 200 may be manipulated by at least one of both hands of the user.

On the other hand, when the user automatically opens the door 200, the user may be holding objects in both hands or may have difficulty opening the door 200 directly for other reasons. Of course, the door 200 may be opened automatically for ease of use.

In order to automatically open the door 200, a specific portion of the door 200 is pressed. In this case, the specific portion may be a portion in which the sensing part 300 is located, and when referring to the embodiment of the present disclosure, the sensing part 300 may be located at a lower left edge of the front surface of the door 200.

That is, when the edge of the door 200 is pressed, the gasket member 210 is compressed by the corresponding pressing force, and thus the facing surfaces between the door 200 and the cabinet 100 are adjacent to each other. When the user presses the other portion of the door 200 without pressing the edge of the door 200, the entire door 200 is pushed backward to compress the gasket member 210 such that the facing surfaces between the door 200 and the cabinet 100 are adjacent to each other.

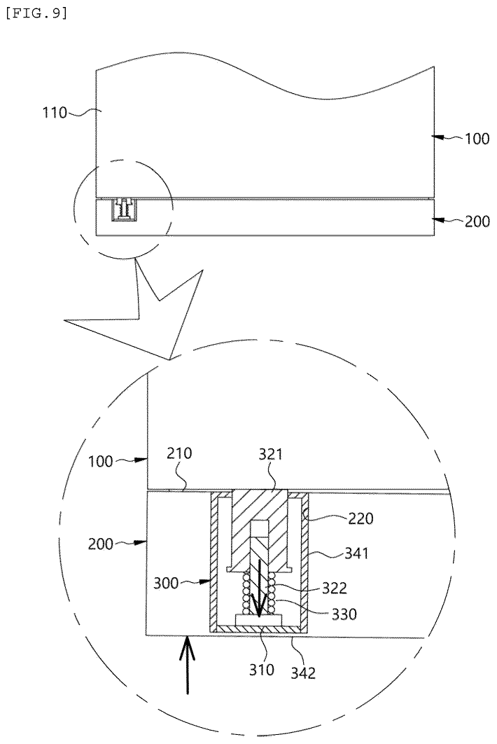

In addition, the pressing member 320 of the sensing part 300 contacts or presses the sensing member 310 while moving in the direction in which the sensing member 310 is located by the adjacent distance. This is as shown in FIG. 9.

As a result, the sensing member 310 senses the user's operation (the opening request of the door) by the contact or pressure of the pressing member 320, and the operation part 420 of the door opening part 400 is operated by the sensed signal.

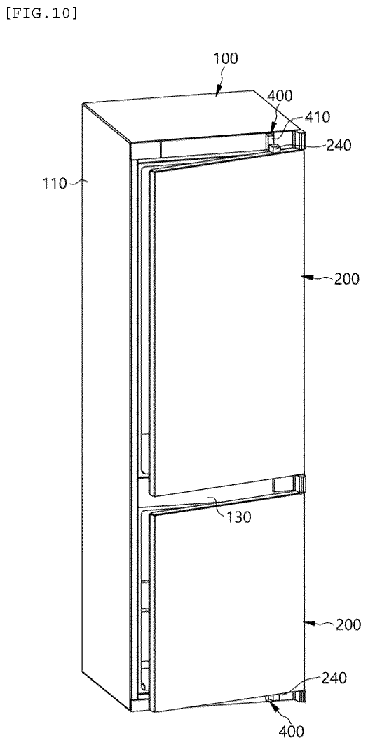

In addition, the push member 410 of the door opening part 400 pushes the door 200 in contact with the push member 410 in the opening direction by the operation of the operation part 420, so that the door 200 is opened by the operation distance of the push member 410. This is shown in FIGS. 10 to 13.

Accordingly, even if both hands are not free, the user may easily open the door 200 opened as described above.

When the door 200 is opened, the pressing member 320 of the sensing part 300 is spaced apart from the sensing member 310 by the restoring force of the restoring member 330, thereby stopping the operation of the operating part 420 of the door opening part 400.

Meanwhile, the user may directly adjust the operating force (the degree of pressing the door, the door pressing pressure) required for the sensing part 300 for sensing. That is, the required operating force is adjusted by adjusting the protruding distance of the contact end 322 from the pressing end 321 forming the pressing member 320 of the sensing part 300.

For example, as the contact end 322 protrudes from the pressing end 321, the sensing member 310 may easily recognize whether the door 200 is pressed even with a small operating force. On the contrary, as the contact end 322 is inserted into the pressing end 321, the operating force required for the sensing member 310 to be recognized is increased.

To adjust the operating force, the sensing part 300 may be separated from the door 200. Then, after separating the lower casing 342 from the upper casing 341, the contact end 322 forming the pressing member 320 is further protruded or further inserted from the pressing end 321.

Of course, the operating force may be adjusted by further protruding or inserting the pressing end 321 from the contact end 322 while only the lower casing 342 is separated without separating the sensing part 300 from the door 200.

As a result, when a specific portion of the door 200 is pressed by a set pressure or more, the refrigerator of the present disclosure is configured to confirm the request by a user to open the door. Thus, a problem in which the door 200 is undesirably opened may be solved.

In addition, the refrigerator of the present disclosure may easily set a desired operating force (door pressing force) by the user by adjusting the protruding distance of the contact end 322 from the pressing end 321.

In addition, according to the present disclosure, since the sensing part 300 is provided in the door 200 in a position where it may be easily separated by the user (or worker), adjustment of the operating force (door pressing force) or maintenance is easily performed. That is, the sensing member 320 may be replaced or adjusted without disassembling the cabinet 100.

Meanwhile, the refrigerator of the present disclosure may be implemented in various forms, unlike the above-described structure.

Although not shown, the sensing part 300 may also be mounted in a structure protruding from the surface of the door 200 rather than being mounted to the inside of the surface of the door 200.

For example, the sensing part 300 may be provided on the bottom surface of the door 200.

Although not shown, the adjustment of the operating force of the sensing part 300 may be performed by adjusting the front and rear position of the sensing member 310. That is, the sensing member 310 is configured to be adjustable in front and rear positions in the casing 340, so that an operating force for confirming the opening request of the door 200 may be adjusted.

In addition, although not shown, the control of the operating force of the sensing part 300 may be configured to be performed by selectively using the plurality of restoring members 330 having different elasticity.

As such, the refrigerator of the present disclosure may be implemented by variously changing the position or number of the sensing part 300 or the structure for adjusting the operating force.

What is claimed is:

1. A refrigerator comprising:
a cabinet having a storage compartment;
a door configured to open and close the storage compartment; and
a sensing part provided in the door and configured to detect an opening request of the door,
wherein the sensing part is configured to detect that the door is pressed by a set pressure in the direction of the cabinet or to detect that the door is pressed by a set pressing distance,

2. The refrigerator of claim 1, further comprising a door opening part configured to open the door by being spaced apart from the cabinet when an opening request of the door is detected by the sensing part.

3. The refrigerator of claim 2, wherein the door opening part comprises a push member disposed on one of the facing surfaces between the cabinet and the door and protruding toward the other facing surface, and an operation part operating the push member.

4. The refrigerator of claim 1, wherein a mounting groove is formed in the door, and the sensing part is mounted in the mounting groove.

5. The refrigerator of claim 1, wherein the sensing part comprises a pressing member configured to move in a direction opposite to the cabinet when the door is pressed, and a sensing member configured to detect the movement of the pressing member.

6. The refrigerator of claim 5, wherein the sensing member comprises at least one of a sensor or a switch disposed on the moving path of the pressing member.

7. The refrigerator of claim 5, wherein the pressing member comprises a pressing end that is pressed while being in contact with the surface opposite to the cabinet, and a contact end that extends from the pressing end and selectively contacts or presses the sensing member.

8. The refrigerator of claim 7, wherein the pressing end is formed to be in surface contact with the cabinet.

9. The refrigerator of claim 7, wherein the contact end is installed such that the distance protruding from the pressing end is adjusted in the moving direction of the pressing member.

10. The refrigerator of claim 5, further comprising a restoring member provided between the facing surfaces of the pressing member and the sensing member to provide a restoring force to move the pressing member.

11. The refrigerator of claim 5, wherein the door is provided with a gasket member for preventing cold air leakage while being in close contact with the facing surface of the cabinet.

12. The refrigerator of claim 11, wherein the pressing member is disposed to have a shorter protrusion distance toward the cabinet than the gasket member.

13. The refrigerator of claim 5, wherein the sensing part includes a casing in which the sensing member is accommodated and at least a portion of the pressing member protrudes.

14. The refrigerator of claim 1, wherein the sensing part is provided on at least one circumferential portion of the door.

15. The refrigerator of claim 1, wherein the sensing part is provided on at least one corner portion of the door.
